(19) United States
(12) Patent Application Publication
(10) Pub. No.: US 2005/0190143 A1
(43) Pub. Date: Sep. 1, 2005

(54) Checkerboard refresh

(75) Inventors: Gregory P. Schmitz, Los Gatos, CA (US); Michael B. Heaney, Palo Alto, CA (US); Stephen B. Jackson, La Honda, CA (US); John R. Duquette, Brighton, MI (US); Steve King, Dexter, MI (US); Tin Pham, (US)

Correspondence Address: PILLSBURY WINTHROP SHAW PITTMAN, LLP, P.O. BOX 10500, MCLEAN, VA, 22102, US

(73) Assignee: PALO ALTO RESEARCH CENTER INCORPORATED

(21) Appl. No.: 11/042,499

(22) Filed: Jan. 24, 2005

Related U.S. Application Data
(60) Provisional application No. 60/548,284, filed on Feb. 27, 2004.

(51) Int. Cl. G09G 3/34

(52) U.S. Cl. 345/107

(57) ABSTRACT

A checkerboard refresh method and system for reliably erasing previously generated images from an electric writeable display. The method and system result in a higher contrast ratio for the electric writeable display than known techniques. In addition, the method and system permit side to side refresh as well as back to front refresh to be performed on an electric writeable display.

### RELATED APPLICATION

This application claims priority under 35 U.S.C. ¶119(e), U.S. Provisional Application Ser. No. 60/548,284 filed 27 Feb. 2004.

### BACKGROUND

Disclosed is a method and system for reliably erasing previously generated images from an electric writeable display. The method and system may result in a higher contrast ratio for the electric writeable display than known techniques. In addition, the method and system permit side to side refresh as well as back to front refresh to be performed on an electric writeable display.

Signs generally comprise printed materials, paper, plastic, metal, etc., and are therefore not programmable. Accordingly, they are not easily changeable. In an attempt to overcome this problem, electronically programmable and/or controllable signs have been in existence for many years. For example, liquid crystal displays (LCD), cathode ray tube (CRT) displays, and other electrically addressable displays will display an image in response to applied electric signals or electromagnetic fields. However, such signs typically require a large amount of electricity, since they must provide illumination in order to be visible to a viewer.

Various types of electric writeable media, some of which are commonly known as rotatable element displays or electric paper displays, also exist in the prior art. One example of a rotatable element display includes a polymer substrate and bichromal rotatable elements such as balls or cylinders that are in suspension with an enabling fluid and are one color, such as white, on one side and a different color, such as black, on the other. Examples of such rotatable element displays are described in U.S. Pat. No. 5,723,204 to Stefik and U.S. Pat. No. 5,604,027 to Sheridon, each of which is incorporated herein by reference in its entirety. Under the influence of an electromagnetic field, the elements rotate so that either the white side or the black side is exposed.

Another type of electric writeable media is known as an electronic ink display, such as the one described in U.S. Pat. No. 6,518,949 to Drzaic, which is incorporated herein by reference. An electronic ink display includes at least one capsule filled with one or more particles made of a material, such as titania, and a dyed suspending fluid. When a direct-current electromagnetic field of an appropriate polarity is applied across the capsule, the particles move to a viewed surface of the display and scatter light. When the applied electromagnetic field is reversed, the particles move to the rear surface of the display and the viewed surface of the display then appears dark.

Yet another type of electric writeable media, also described in U.S. Pat. No. 6,518,949 to Drzaic, includes a first set of particles and a second set of particles in a capsule. The first set of particles and the second set of particles have contrasting optical properties, such as contrasting colors, and can have, for example, differing electrophoretic properties. The capsule also contains a substantially clear fluid. The capsule has electrodes disposed adjacent to it connected to a voltage source, which may provide an alternating-current field or a direct-current field to the capsule. Upon application of an electromagnetic field across the electrodes, the first set of particles move toward one electrode, while the second set of particles move toward the second electrode.

Other examples of writeable media include liquid crystal displays, encapsulated electrophoretic displays, and other displays.

Electric writeable displays can be more useful than LCD and CRT type displays since electric writeable displays are suitable for viewing in ambient light and they can be made to be very lightweight and/or flexible. For further description of such displays, see U.S. Pat. No. 5,389,945 to Sheridon, incorporated herein by reference in its entirety. An example of such a display is a SmartPaper® display from Gyricon LLC.

Electric writeable displays can retain an image in the absence of an applied electromagnetic field (i.e., without using any power). However, to display a new image on an electric writeable display, the old image must be erased. If the old image is not completely erased, a latent or residual image remains on the display. The retention of a latent or residual image can make it difficult for a viewer to interpret the new image. Possible problems may include a lower contrast ratio (i.e., a lower ratio of white reflectance to black reflectance on the display surface) or extra characters or words visible from the old message.

To erase an image in an electric writeable display, the elements (e.g., balls) of the display are rotated from black to white. However, forces, such as electrostatic forces, may hold the elements in place even if an electromagnetic field is applied. The balls may overcome these forces by being repeatedly changed from black to white. One way to erase an old image is by applying a ‘blank’ refresh pattern where the entire image is subject to a uniform applied electromagnetic field. Exemplary refresh techniques are shown in FIGS. 1A (Refresh White) and 1B (Refresh Black). By repeatedly writing the Refresh Black and Refresh White patterns, the elements of an electric writeable display are loosened and the image is erased. This technique uses electromotive force (e.g., potential or voltage) to move the balls from front (e.g., pixel) to back (e.g., conductive layer). Once the image is erased, the electric writeable display can form the pattern for a new image.

Known refresh techniques produce electromotive force in one dimension (front to back). Accordingly, the required number of cycles to erase an electric writeable display can be substantial.

What is needed is a method and system for reliably erasing an old image from an electric writeable display. A further need exists for a method and system for erasing an old image from an electric writeable display that results in a higher contrast ratio. A still further need exists for a method and system for erasing an old image from an electric writeable display that permits side to side refresh as well as front to back refresh.

### SUMMARY

Aspects disclosed herein include

a method for erasing an electric writeable display, wherein the electric writeable display includes a substrate including one or more conductive sections, a layer of bichromal media having one or more regions, and a transparent conductive layer, wherein the bichromal media is positioned between the substrate and the conductive layer, the method comprising
applying a first electromagnetic field having a first polarity to one or more first regions and no electromagnetic field to one or more second regions, wherein at least one second region is adjacent to each first region;
applying a second electromagnetic field having a first polarity to the one or more second regions and no electromagnetic field to the one or more first regions;
applying a third electromagnetic field having a second polarity to the one or more first regions and no electromagnetic field to the one or more second regions, wherein the second polarity is the opposite of the first polarity; and
applying a fourth electromagnetic field having a second polarity to the one or more second regions and no electromagnetic field to the one or more first regions, wherein the bichromal media of each region display a first color after applying the fourth electromagnetic field.

A time differential may be applied between application of different electromagnetic fields. For example, a time differential of from about 0.05 seconds to 10 seconds may be employed, or alternatively from about 0.2 seconds to about 0.7 seconds.

The pattern developed may be unipolar, bipolar, multipolar and other patterns.
Further aspects include: a method comprising erasing an electric writeable display, wherein the electric writeable display includes a substrate including one or more conductive sections, a layer of media, whose optical reflectance can be varied, having one or more regions, and a transparent conductive layer, wherein the imageable media is positioned between the substrate and the conductive layer, the method further comprising applying a first electromagnetic field having a first polarity to one or more first regions and no electromagnetic field to one or more second regions, wherein at least one second region is adjacent to each first region; applying a second electromagnetic field having a first polarity to the one or more second regions and no electromagnetic field to the one or more first regions; applying a third electromagnetic field having a second polarity to the one or more first regions and no electromagnetic field to the one or more second regions, wherein the second polarity is the opposite of the first polarity; and applying a fourth electromagnetic field having a second polarity to the one or more second regions and no electromagnetic field to the one or more first regions, wherein the imageable media of each region display a first color after applying the fourth electromagnetic field.

The vector sum of the first, second, third and fourth electromagnetic fields may equal zero.

### BRIEF DESCRIPTION OF DRAWINGS

FIGS. 1A and 1B show an exemplary refresh technique.

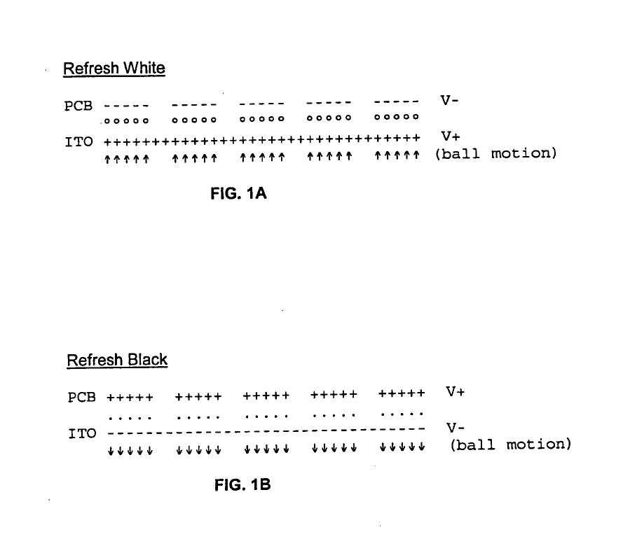

FIG. 2 is a cross-sectional view of an exemplary electric writeable display device with plate and pixel drivers.

FIGS. 3A through 3D show diagrammatic representations of exemplary driving operations on electric writeable displays.

FIGS. 4A through 4D depict an exemplary refresh technique according to an embodiment.

FIG. 5 shows the electromagnetic field strength between adjacent pixel segments of an electric writeable display during an exemplary refresh cycle according to an embodiment.

FIG. 6 shows an exemplary image on an electric writeable display.

### DETAILED DESCRIPTION

In embodiments there is illustrated:

a method and system for reliably erasing previously generated images from an electric writeable display. The method and system result in a higher contrast ratio for the electric writeable display than known techniques. In addition, the method and system permit side to side refresh as well as back to front refresh to be performed on an electric writeable display.

A basic structure of an exemplary electric writeable display is shown in U.S. Pat. No. 4,126,854, incorporated herein by reference. This disclosure relates to the electrical interface and methods of applying voltage waveforms to erase images on an electric writeable display.

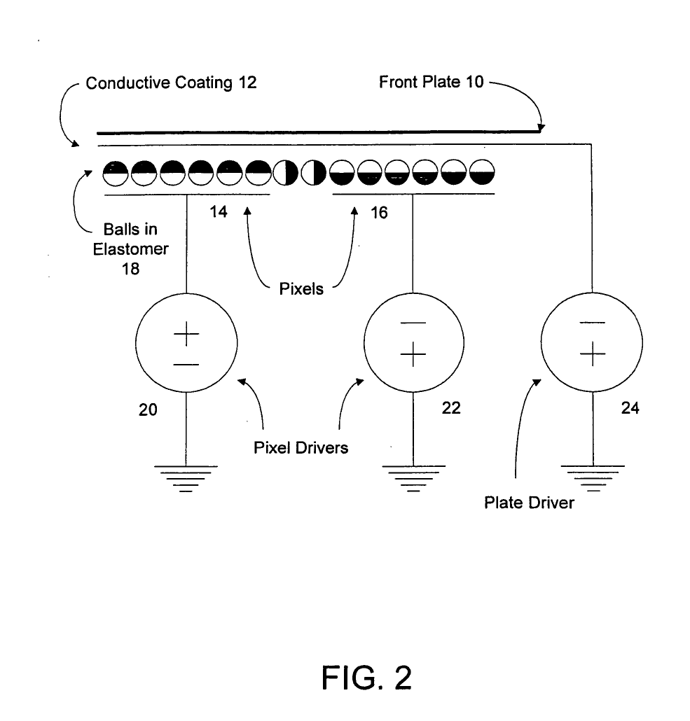

An example of the basic elements of an exemplary electric writeable display structure is illustrated in FIG. 2. In this illustration, the electric writeable display includes a layer of balls 18. Each ball has two distinct hemispheres, one having a first color (such as black) and the other having a second color (such as white). Each hemisphere of each ball has a distinct electrical characteristic so that the balls are electrically anisotropic. Instead of balls, cylinders and other shapes may be used, so long as each item is rotatable and has distinct half-areas with distinct colors. In addition, other electric writeable displays, such as liquid crystal displays and encapsulated electrophoretic displays may be used.

The balls are embedded in an optically transparent material, such as an elastomer layer. The elastomer layer may contain a multiplicity of spherical cavities (or cavities of other shapes if cylinders or other items are used in the layer) and may be permeated by a transparent dielectric fluid, such as a plasticizer. The fluid-filled cavities may accommodate the balls 18, one ball per cavity, to prevent the balls from migrating within the sheet. FIG. 2 illustrates a layer of balls 18 having balls disposed in straight lines. However, the illustrated example is not meant to be limiting, and this embodiment may be used with any three-dimensional grouping of the balls.

The ball layer 18 is sandwiched between a transparent conductive coating 12, that is covered by or integral with front plate 10, and one or more conductive pixels such as 14 and 16 formed on a substrate as shown in FIG. 2. The front plate 10 is typically plastic (such as Mylar®) or glass. The conductive layer 12 may be made, for example, of indium tin oxide (ITO) to provide both transparency and the ability to apply a uniform electromagnetic field. As used herein, the term “transparent” is intended to include substantially transparent.

A ball may be selectively rotated within its fluid-filled cavity by the application of an electromagnetic field to the pixel located proximate to its cavity. Thus, the application of a field to a pixel may present either the black or the white hemisphere of the balls located over the pixel to an observer viewing the surface of the sheet (i.e., the front plate). Thus, by application of an electromagnetic field addressable in two dimensions (as by a matrix addressing scheme), the black and white sides of the balls can be caused to appear as the image elements (e.g., pixels or subpixels) of a displayed image. Note that the use of black and white hemispheres is only illustrative, and that other colors may be used. In addition, balls having differing colors may be used in an embodiment. For example, an electric writeable display may have three sets of balls, such as black-red, black-green and black-blue to implement a color electric writeable display. Other implementations are also within the scope of this disclosure.

The electromagnetic field is generated by the voltage sources, specifically, by pixel drivers 20 and 22 and the plate driver 24. The number of pixels and pixel drivers, and the electromagnetic field source illustrated in FIG. 2 is only intended to serve as an example, and any number of pixels and pixel drivers may be used, as well as other field sources—electrical (voltage) or magnetic (current). The pixel drivers may also be contained in a separate unit (e.g., a wand or stylus) that is swept over the surface of the pixels, in a procedure analogous to printing.

Electromagnetic fields impressed across the electric writeable display may set the optical state, or color, of the display. These electromagnetic fields are generated by voltage waveforms. The disclosed embodiments may apply to all forms of electric writeable displays that form stable, static images. When this is the case, the image remains static when external voltages are removed. In other words, the application of an electromagnetic field may cause a ball to rotate, but the removal of the field may not change the position or orientation of the ball.

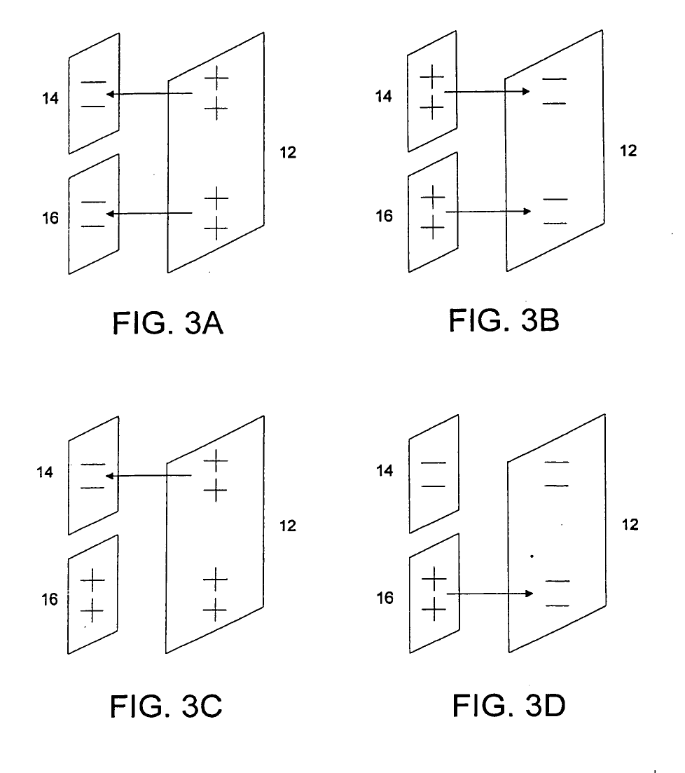

The balls may each have an intrinsic electric dipole so that the orientation of a ball conforms to an applied electromagnetic field. This is illustrated in FIGS. 3A through 3D (balls not shown for ease of illustration). As shown in FIG. 3A, when the field of the conductive layer 12 of the front plate is positive while pixels 14 and 16 are negative, a field (represented by the arrows) is generated so that the white side of the balls associated with each of pixels 14 and 16 may be seen through the front plate. Conversely, as shown in FIG. 3B, a negative conductive layer 12 and positive pixels 14 and 16 may cause the black side of the balls to be seen through the front plate. Throughout this document, the colors black and white are used only to illustrate contrasting examples; in fact any two colors, which may include two shades of a single color, may be used within the scope of this disclosure.

When the pixel voltage is the same as the plate voltage, the balls controlled by that pixel will not change. Examples of such a condition are shown in FIGS. 3C and 3D. Thus, as illustrated in FIG. 3C, if we start with an image where the black sides of all the balls are facing the viewer, we can drive the pixels associated with pixel 14 white by making pixel 14 negative with respect to conductive layer 12. Since both pixel 16 and conductive layer 12 are positive, no field is generated between the conductive layer 12 and pixel 16, and the balls associated with pixel 16 remain black to the viewer. Conversely, if all balls begin in the white position, we can drive some of them black by making certain pixels positive with respect to a negative conductive layer. In FIG. 3D, pixel 16 is positive and pixel 14 and conductive layer 12 are negative, so the balls associated with pixel 16 rotate to the black position.

In FIG. 3, standard directions are used to illustrate the electromagnetic field lines. As shown, electromagnetic field lines originate on positive charges and terminate on negative charges. No electromagnetic field is present between charges at the same voltage.

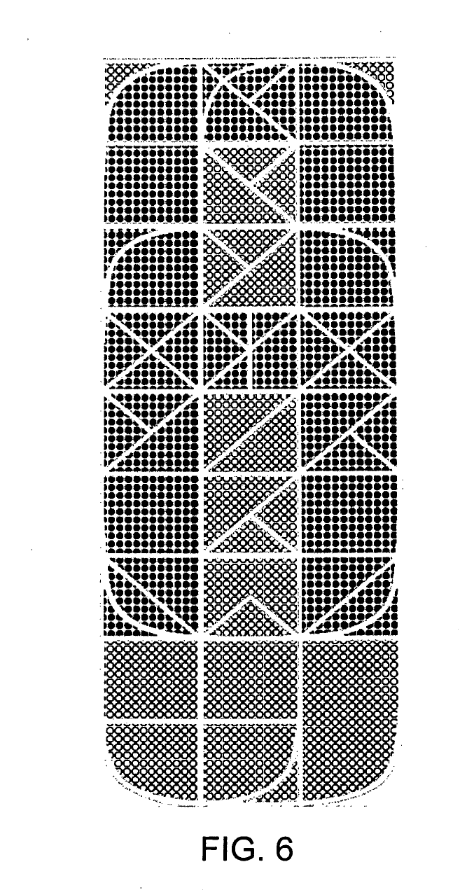

In an embodiment, one or more balls may be rotated into a pattern corresponding to a desired image by applying localized electromagnetic fields to the conductive layer 12 and the one or more pixels, such as 14 and 16, of the electric writeable display. An exemplary image is shown in FIG. 6. The one or more balls of the electric writeable display may maintain their orientation and display the image until they are erased.

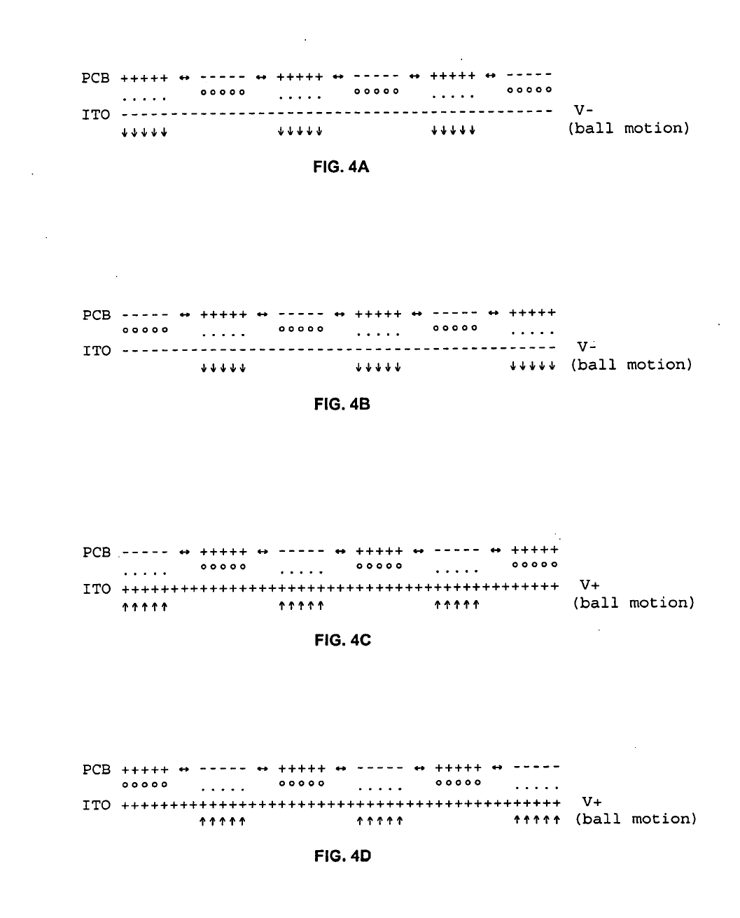

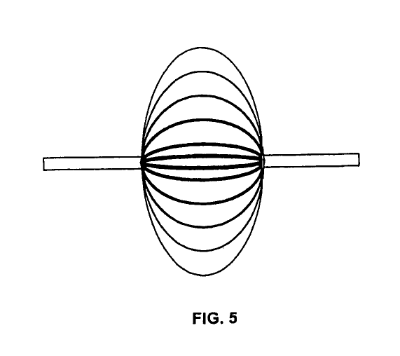

FIGS. 4A through 4D depict an exemplary refresh technique according to an embodiment. While demonstrating in these embodiments a unipolar pattern, the pattern may alternatively be bipolar, multipolar or another pattern. The refresh technique employed in FIGS. 4A and 4D may be used to erase an electric paper display. With this refresh technique (i.e., the checkerboard refresh technique), adjacent pixel segments of the electric writeable display are driven in opposite directions. Accordingly, the balls of the electric writeable display may have a side to side electromotive force (i.e., between pixel segments) applied to them as well as a front to back electromotive force (i.e., from pixel segments to conductive layer). FIG. 5 represents the electromagnetic field strength between adjacent pixel segments of an electric writeable display during a refresh cycle according to an embodiment. The field strength may generate an electromotive force that aids in loosening the balls.

Differing alternating patterns may be used to implement this technique. In embodiments, sequential pixels in either a horizontal or vertical direction may include, for example, a pattern such as one of the following:
ON-OFF-ON-OFF-ON-OFF-ON-OFF;
ON-ON-OFF-OFF-ON-ON-OFF-OFF;
ON-ON-ON-ON-OFF-OFF-OFF-OFF;

the inverse of each of the above patterns;

a custom pattern for a specific electric writeable display layout to ensure that adjacent segments are at different voltage levels; and

a random pattern.

Additional or alternative patterns may be used to implement a refresh technique according to embodiments.

It will be appreciated that variations of the above-disclosed embodiments and other features and functions, or alternatives thereof, may be desirably combined into many other different devices or applications. Also that various presently unforeseen or unanticipated alternatives, modifications, variations or improvements therein may be subsequently made by those skilled in the art which are also intended to be encompassed by the following claims.

1. A method comprising
erasing an electric writeable display, wherein the electric writeable display includes a substrate including one or more conductive sections, a layer of imageable media, whose optical reflectance can be varied, having one or more regions, and a transparent conductive layer, wherein the imageable media is positioned between the substrate and the conductive layer, the method further comprising
applying a first electromagnetic field having a first polarity to one or more first regions and no electromagnetic field to one or more second regions, wherein at least one second region is adjacent to each first region;
applying a second electromagnetic field having a first polarity to the one or more second regions and no electromagnetic field to the one or more first regions;
applying a third electromagnetic field having a second polarity to the one or more first regions and no electromagnetic field to the one or more second regions, wherein the second polarity is the opposite of the first polarity; and
applying a fourth electromagnetic field having a second polarity to the one or more second regions and no electromagnetic field to the one or more first regions, wherein the imageable media of each region display a first color after applying the fourth electromagnetic field.

2. The method in accordance with claim 1 wherein the vector sum of the first, second, third and fourth electromagnetic fields equals zero.
